(19) United States
(12) Patent Application Publication
(10) Pub. No.: US 2025/0298652 A1
(43) Pub. Date: Sep. 25, 2025

(54) Hypervisor-Directed Central Processing Unit Utilization

(71) Applicant: International Business Machines Corporation, Armonk, NY (US)

(72) Inventors: Tobias Huschle, Gaertringen (DE); Norman Christopher Böwing, Böblingen (DE); Mete Durlu, Boeblingen (DE)

(21) Appl. No.: 18/615,123

(22) Filed: Mar. 25, 2024

(51) Int. Cl. G06F 9/455

(52) U.S. Cl. CPC G06F 9/45558

(57) ABSTRACT

Hypervisor-directed usage of central processing unit (CPU) resources is provided. A hypervisor determines a logical to physical CPU relationship mapping between a subset of a plurality of logical central processing units (CPUs) and a subset of a plurality of physical CPUs using a CPU topology of a computer. The hypervisor distributes information regarding additional available processing capacity of at least one physical CPU to a plurality of guest virtual machines on a per-logical CPU basis based on the logical to physical CPU relationship mapping between the subset of the plurality of logical CPUs and the subset of the plurality of physical CPUs enabling the plurality of guest virtual machines to distribute workload based on predicted processing capacities of corresponding logical CPUs.

### BACKGROUND

The disclosure relates generally to virtualization and more specifically to resource utilization in a virtualized environment.

Virtualization is a process that allows for efficient use of physical computer hardware and is typically utilized in cloud computing. Virtualization creates an abstraction layer over computer hardware, enabling the division of a single computer's hardware components, such as, for example, processors, memory, storage, and the like, into multiple virtual machines. Each virtual machine runs its own operating system and performs like an independent computer, even though the virtual machine is running on just a portion of the actual underlying computer hardware. As a result, virtualization enables more efficient use of physical computer hardware.

A hypervisor or virtual machine monitor is a type of computer software, firmware, or hardware that generates and runs the virtual machines. A computer on which a hypervisor runs virtual machines is called a host physical machine, and each virtual machine is called a guest virtual machine.

### SUMMARY

According to one illustrative embodiment, a computer-implemented method for hypervisor-directed usage of central processing unit (CPU) resources is provided. A computer, using a hypervisor, determines a logical to physical CPU relationship mapping between a subset of a plurality of logical central processing units (CPUs) and a subset of a plurality of physical CPUs using a CPU topology of the computer. The computer, using the hypervisor, distributes information regarding additional available processing capacity of at least one physical CPU to a plurality of guest virtual machines on a per-logical CPU basis based on the logical to physical CPU relationship mapping between the subset of the plurality of logical CPUs and the subset of the plurality of physical CPUs enabling the plurality of guest virtual machines to distribute workload based on predicted processing capacities of corresponding logical CPUs. According to other illustrative embodiments, a computer system and computer program product for hypervisor-directed CPU utilization are provided.

### BRIEF DESCRIPTION OF THE DRAWINGS

FIG. 1 is a pictorial representation of a computing environment in which illustrative embodiments may be implemented;

FIG. 2 is a diagram illustrating an example of a physical host computer in accordance with an illustrative embodiment;

FIG. 3 is a diagram illustrating an example of a scheduling process in accordance with an illustrative embodiment;

FIG. 4 is a diagram illustrating an example of a mapping process in accordance with an illustrative embodiment;

FIG. 5 is a diagram illustrating an example of 100% logical to physical CPU mapping process in accordance with an illustrative embodiment;

FIG. 6 is a diagram illustrating an example of 50% logical to physical CPU mapping process in accordance with an illustrative embodiment;

FIG. 7 is a diagram illustrating an example of 0% logical to physical CPU mapping process in accordance with an illustrative embodiment;

FIG. 8 is a diagram illustrating an example of an avoiding collisions process in accordance with an illustrative embodiment;

FIG. 9 is a diagram illustrating an example of a hypervisor-directed CPU utilization process in accordance with an illustrative embodiment; and

FIGS. 10A-10B are a flowchart illustrating a process for hypervisor-directed usage of CPU resources in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

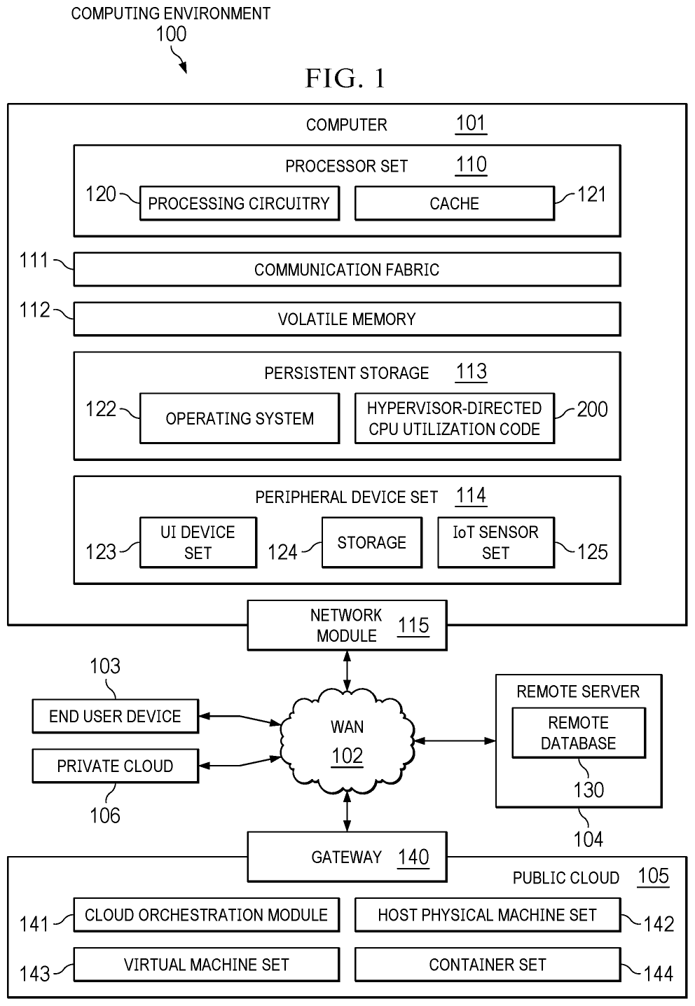

With reference now to the figures, and in particular, with reference to FIGS. 1-9, diagrams of data processing environments are provided in which illustrative embodiments may be implemented. It should be appreciated that FIGS. 1-9 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as hypervisor-directed central processing unit (CPU) utilization code 200.

For example, illustrative embodiments implement hypervisor-directed CPU utilization code 200 in a hypervisor. The hypervisor, utilizing hypervisor-directed CPU utilization code 200 of illustrative embodiments, distributes physical CPU allocation information that the hypervisor generated regarding available processing capacity to guest virtual machines, which the hypervisor monitors, to allow improved physical CPU utilization and increased throughput on all guest virtual machines of a single physical host computer (e.g., computer 101). The guest virtual machines share a subset of a plurality of physical CPUs (e.g., processor set 110) and other resources on the physical host computer, but the guest virtual machines do not share the application workload running on each of the guest virtual machines.

In addition to hypervisor-directed CPU utilization code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and hypervisor-directed CPU utilization code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, physical computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in hypervisor-directed CPU utilization code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a system administrator who utilizes the hypervisor-directed CPU utilization provided by computer 101), and may take any of the forms discussed above in connection with computer 101. EUD 103 typically receives helpful and useful data from the operations of computer 101. For example, in a hypothetical case where computer 101 is designed to provide a CPU allocation recommendation to the end user, this recommendation would typically be communicated from network module 115 of computer 101 through WAN 102 to EUD 103. In this way, EUD 103 can display, or otherwise present, the CPU allocation recommendation to the end user. In some embodiments, EUD 103 may be a client device, such as thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a CPU allocation recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In a virtualized environment, illustrative embodiments utilize a hypervisor to predict resource (i.e., physical CPU) consumption by a plurality of guest virtual machines running on a physical host computer and provide physical CPU allocation recommendations to the guest virtual machines. The hypervisor of illustrative embodiments works with the guest virtual machines to increase physical CPU utilization. Thus, the hypervisor of illustrative embodiments provides centralized computing of predictions instead of the prediction computing being performed by each individual guest virtual machine running on the physical host computer. As a result, the hypervisor of illustrative embodiments decreases workload collisions and migration at the physical CPU level, which increases overall performance of the physical host computer.

Thus, illustrative embodiments provide one or more technical solutions that overcome a technical problem with each individual guest virtual machine performing the physical CPU allocation calculations, which creates workload scheduling collisions on physical CPUs between the guest virtual machines, which decreases overall physical host computer performance. As a result, these one or more technical solutions provide a technical effect and practical application in the field of virtualized environments and hypervisors.

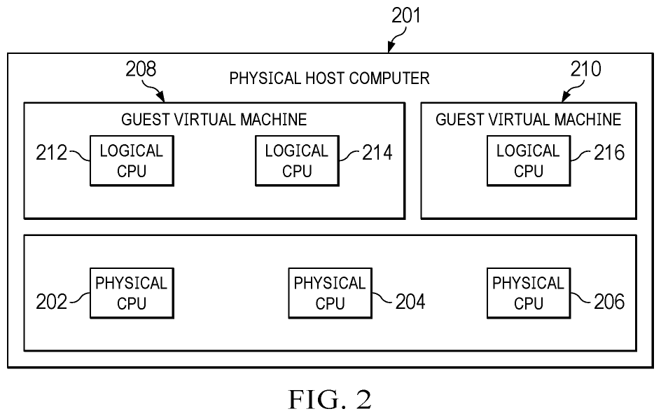

With reference now to FIG. 2, a diagram illustrating an example of a physical host computer is depicted in accordance with an illustrative embodiment. Physical host computer 201 may be, for example, computer 101 in FIG. 1. Physical host computer 201 is a system of hardware and software components for hypervisor-directed CPU utilization.

In this example, physical host computer 201 includes 3 physical CPUs, physical CPU 202, physical CPU 204, and physical CPU 206. Physical CPU 202, physical CPU 204, and physical CPU 206 may be, for example, processor set 110 in FIG. 1. In addition, physical host computer 201 includes 2 guest virtual machines, guest virtual machine 208 and guest virtual machine 210. Guest virtual machine 208 includes 2 logical CPUs, logical CPU 212 and logical CPU 214. Guest virtual machine 210 includes 1 logical CPU, logical CPU 216. However, it should be noted that physical host computer 201 is intended as an example only and not as a limitation on illustrative embodiments. For example, physical host computer 201 can include any number of physical CPUs and any number of guest virtual machines having any number of logical CPUs, as well as other devices and components not shown.

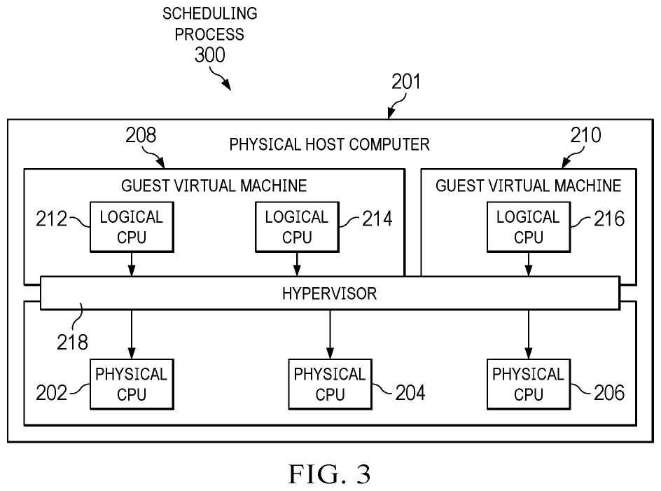

With reference now to FIG. 3, a diagram illustrating an example of a scheduling process is depicted in accordance with an illustrative embodiment. Scheduling process 300 is implemented in physical hosts computer 201.

Physical hosts computer 201 includes hypervisor 218. Hypervisor 218 is implemented by, for example, hypervisor-directed CPU utilization code 200 in FIG. 1. Hypervisor 218 schedules logical CPU 212 and logical CPU 214 of guest virtual machine 208, along with logical CPU 216 of guest virtual machine 210, to consume runtime on any of physical CPU 202, physical CPU 204, and physical CPU 206, depending on processing capacity individually allocated by hypervisor 218 to logical CPU 212, logical CPU 214, and logical CPU 216.

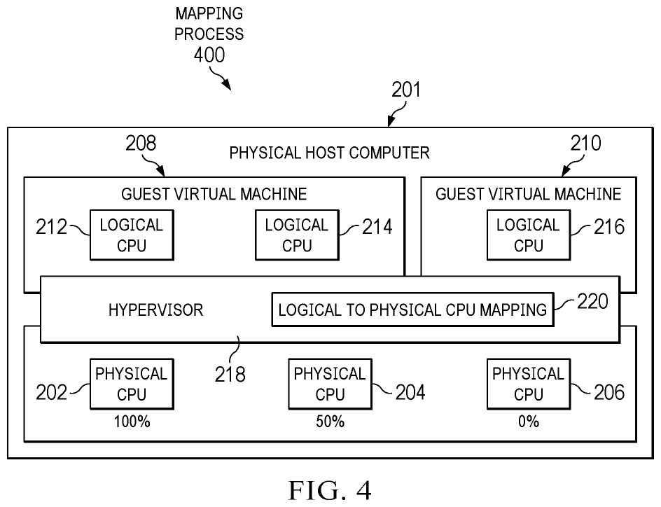

With reference now to FIG. 4, a diagram illustrating an example of a mapping process is depicted in accordance with an illustrative embodiment. Mapping process 400 is implemented in physical host computer 201.

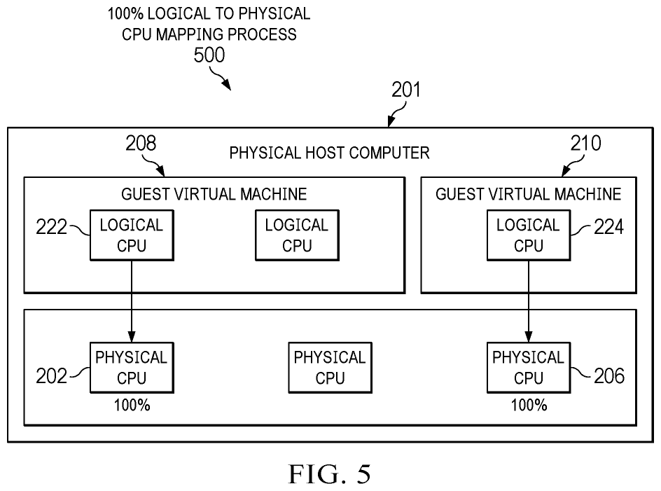

Hypervisor 218 maps relationships between a plurality of logical CPUs, such as logical CPU 212 and logical CPU 214 of guest virtual machine 208 and logical CPU 216 of guest virtual machine 210, and a plurality of physical CPUs, such as physical CPU 202, physical CPU 204, and physical CPU 206, to generate logical to physical CPU mapping 220 based on the CPU topology of physical host computer 201. In addition, hypervisor 218 determines the possible physical CPU consumption per logical CPU based on the CPU topology of physical host computer 201. For example, hypervisor 218 maps logical CPU 212 to physical CPU 202 for 100% allocated runtime on physical CPU 202, logical CPU 214 to physical CPU 204 for 50% allocated runtime on physical CPU 204, and logical CPU 216 to physical CPU 206 for 0% allocated runtime on physical CPU 206. However, FIG. 4 does not illustrate these mappings from logical to physical CPUs. FIGS. 5-7 below do illustrate the different logical to physical CPU mappings.

With reference now to FIG. 5, a diagram illustrating an example of 100% logical to physical CPU mapping process is depicted in accordance with an illustrative embodiment. 100% logical to physical CPU mapping process 500 is implemented in physical host computer 201.

In this example, a hypervisor, such as, for example, hypervisor 218 of FIG. 4, maps logical CPU 222 of guest virtual machine 208 to run on physical CPU 202 and logical CPU 224 of guest virtual machine 210 to run on physical CPU 206 for 100% allocated runtime. In other words, logical high CPU 222 and logical high CPU 224 will always have runtime on physical CPU 202 and physical CPU 206, respectively.

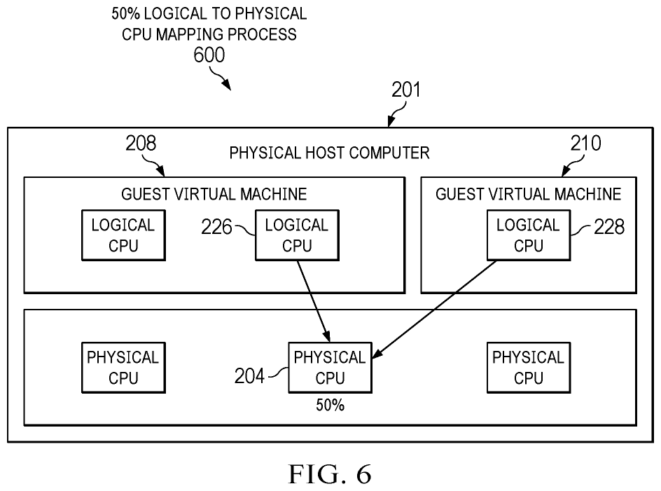

With reference now to FIG. 6, a diagram illustrating an example of 50% logical to physical CPU mapping process is depicted in accordance with an illustrative embodiment. 50% logical to physical CPU mapping process 600 is implemented in physical host computer 201.

In this example, a hypervisor, such as, for example, hypervisor 218 of FIG. 4, maps logical CPU 226 of guest virtual machine 208 and logical CPU 228 of guest virtual machine 210 to run on physical CPU 204 for a percentage of allocated runtime on physical CPU 204. In this example, logical CPU 226 and logical CPU 228 equally share 50% allocated runtime on physical CPU 204. However, it should be noted that the hypervisor can allocate any percentage ratio of runtime (e.g., 50/50, 60/40, 70/30, 75/25, 80/20, 90/10, or the like) between logical CPU 226 and logical CPU 228.

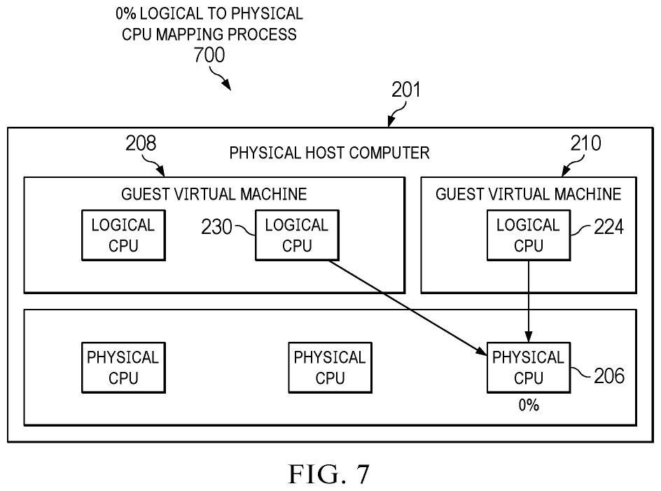

With reference now to FIG. 7, a diagram illustrating an example of 0% logical to physical CPU mapping process is depicted in accordance with an illustrative embodiment. 0% logical to physical CPU mapping process 700 is implemented in physical host computer 201.

In this example, a hypervisor, such as, for example, hypervisor 218 of FIG. 4, maps logical CPU 230 of guest virtual machine 208 and logical CPU 224 of guest virtual machine 210 to run on physical CPU 206. However, it should be noted that logical CPU 230 is not guaranteed any runtime (0%) on physical CPU 206. In other words, the hypervisor can schedule workload on logical CPU 230, but logical CPU 230 will only receive runtime on physical CPU 206 when logical CPU 224 is not consuming 100% allocated runtime on physical CPU 206. Consequently, logical CPU 230 remains in an idle state until logical CPU 230 receives runtime on physical CPU 206 when logical CPU 224 is under consuming allocated runtime on physical CPU 206.

Thus, scheduling workload on logical CPU 230 is speculative because logical CPU 230 is not guaranteed a percentage of processing runtime. As a result, logical CPU 230 may not receive runtime on a physical CPU for an extended period of time. However, the hypervisor can increase performance of physical host computer 201 by predicting that a particular logical CPU, such as logical CPU 224, will not consume 100% runtime of its corresponding physical CPU based on determined physical CPU usage patterns of that particular logical CPU and provide a recommendation to a guest virtual machine to have a logical 0% CPU of that guest virtual machine to consume the predicted remaining unconsumed percentage of runtime of that particular physical CPU.

It should be noted that the hypervisor of illustrative embodiments (e.g., hypervisor 218) predicts the runtime consumption of physical CPUs as opposed to each guest virtual machine performing the prediction individually, which is currently performed today. Also, it shall be noted that the guest virtual machines have no insight into the actual logical to physical mappings, which may impact the quality of predictions of the guest virtual machines. Furthermore, in more restricted computer systems, the guest virtual machines may not have access to the CPU consumption data of other guest virtual machines at all, making predictions impossible. The hypervisor of illustrative embodiments performs the prediction for all of the guest virtual machines running on the physical host computer on a predefined time interval basis, thus avoiding workload scheduling collisions on a physical CPU between guest virtual machines.

The hypervisor of illustrative embodiments provides predicted physical CPU usage information to the guest virtual machines as to the percentage of runtime that each respective guest virtual machine can potentially consume of a particular physical CPU, which that percentage of physical CPU runtime would not normally be available to that particular guest virtual machine without the hypervisor of illustrative embodiments providing that information. Thus, the hypervisor of illustrative embodiments enables usage of additional physical CPU processing capacity by a guest virtual machine without having to change configuration of actual hardware of physical host computer 201. As a result, the hypervisor of illustrative embodiments ensures less overhead than assigning more logical CPUs to guest virtual machines because the mapping of logical to physical CPUs does not change. Consequently, cooperation between the hypervisor of illustrative embodiments and the guest virtual machines decreases workload migration on the physical CPUs by the guest virtual machines.

It should be noted that current hypervisors try to fulfil performance needs for as many guest virtual machines as possible, which implies migration of workload between physical CPUs or complex scheduling calculations. In contrast, guest virtual machines select specific logical CPUs to run workload based on knowledge of predicted available physical CPU capacity, which the hypervisor of illustrative embodiments provides, and workload characteristics. The hypervisor of illustrative embodiments can predict how workload can be distributed in the future based on the hypervisor identifying physical CPU usage patterns by the guest virtual machines. Thus, the hypervisor of illustrative embodiments increases performance of physical host computer 201 by preventing workload migration overhead.

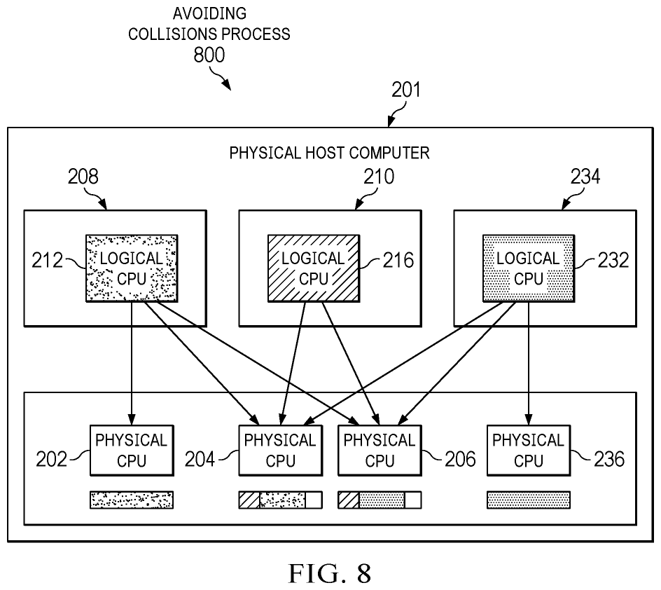

With reference now to FIG. 8, a diagram illustrating an example of an avoiding collisions process is depicted in accordance with an illustrative embodiment. Avoiding collisions process 800 is implemented in physical host computer 201.

In this example, a hypervisor, such as, for example, hypervisor 218 of FIG. 4, schedules logical CPU 212 of guest virtual machine 208 to have 100% allocated runtime on physical CPU 202. In addition, the hypervisor schedules logical CPU 216 of guest virtual machine 210 to have 100% allocated runtime on physical CPU 204 and physical CPU 206. Further, the hypervisor schedules logical CPU 232 of guest virtual machine 234 to have 100% allocated runtime on physical CPU 236.

It should be noted that guest virtual machine 208 and guest virtual machine 234 may use an arbitrary logical CPU, thereby causing collisions. However, the hypervisor predicts the opportunity and need to overconsume and, therefore, directs guest virtual machine 208 and guest virtual machine 234 to use a different physical CPU, such as physical CPU 204 and physical CPU 206. In the event that one of guest virtual machine 208 and guest virtual machine 234 does not consume the full amount of unused physical CPU capacity, then that particular guest virtual machine can decide to additionally fit a small task onto that physical CPU, while being aware that it may see less runtime.

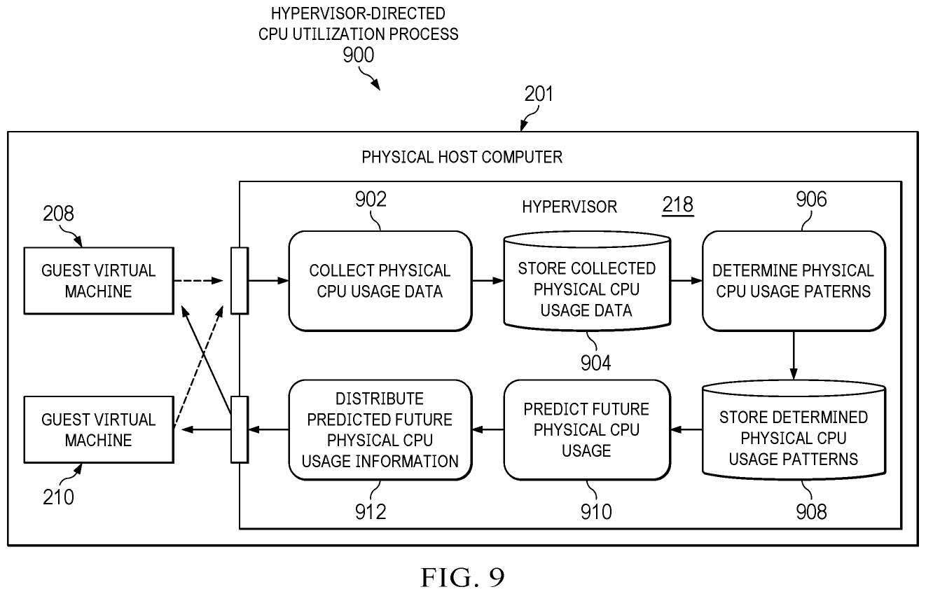

With reference now to FIG. 9, a diagram illustrating an example of a hypervisor-directed CPU utilization process is depicted in accordance with an illustrative embodiment. Hypervisor-directed CPU utilization process 900 is implemented in physical host computer 201.

In this example, hypervisor-directed CPU utilization process 900 starts at 902 where hypervisor 218 collects physical CPU usage data from guest virtual machine 208 and guest virtual machine 210 over a defined period of time. At 904, hypervisor 218 stores the collected physical CPU usage data over the defined period of time. At 906, the hypervisor determines physical CPU usage patterns of guest virtual machine 208 and guest virtual machine 210 based on the hypervisor analyzing the CPU usage data collected over the period of time.

At 908, the hypervisor stores the determined physical CPU usage patterns of guest virtual machine 208 and guest virtual machine 210. At 910, the hypervisor predicts future physical CPU usage of guest virtual machine 208 and guest virtual machine 210 based on the determined physical CPU usage patterns of guest virtual machine 208 and guest virtual machine 210. At 912, the hypervisor distributes the predicted future physical CPU usage information to guest virtual machine 208 and guest virtual machine 210 enabling guest virtual machine 208 and guest virtual machine 210 to distribute application workload to corresponding logical CPUs avoiding workload collisions and migrations on physical CPUs of physical host computer 201. Alternatively, the hypervisor allocates physical CPU runtime to guest virtual machine 208 and guest virtual machine 210 based on the predicted future physical CPU usage of guest virtual machine 208 and guest virtual machine 210.

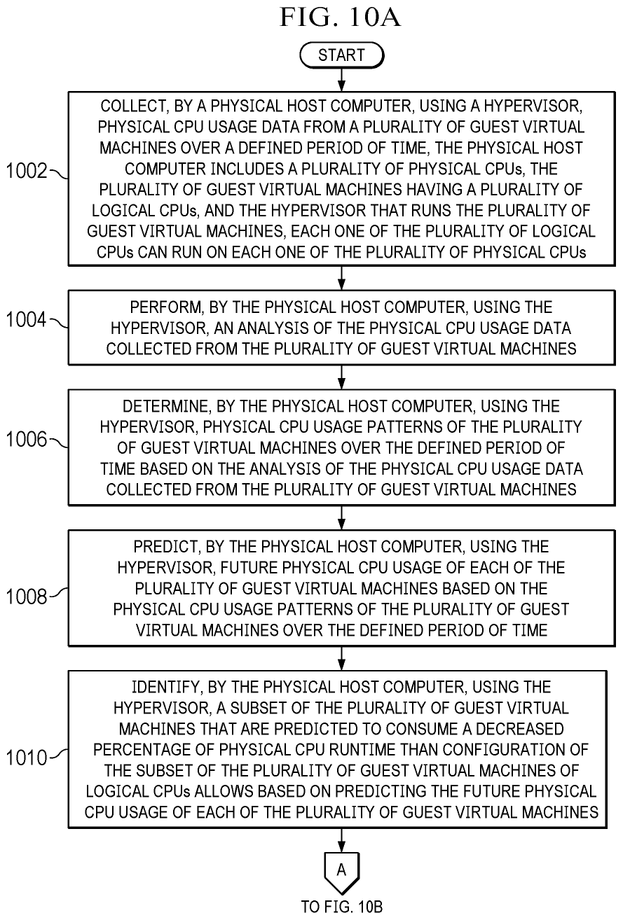

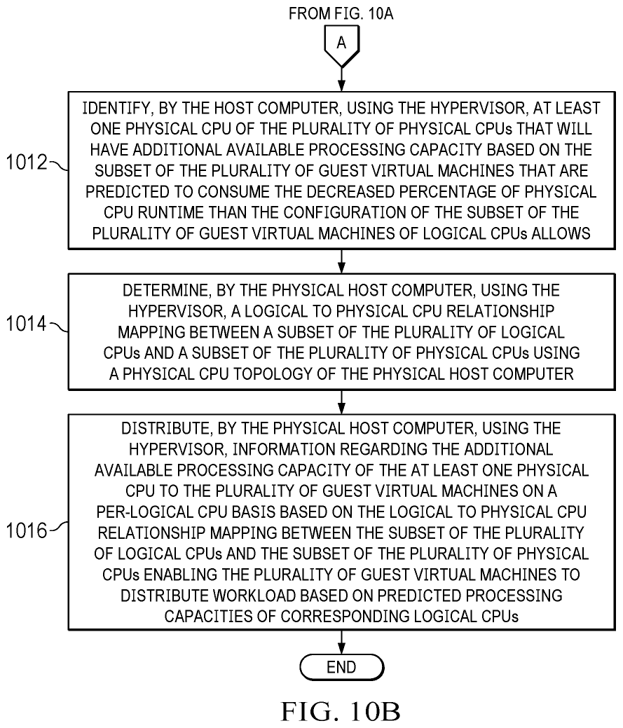

With reference now to FIGS. 10A-10B, a flowchart illustrating a process for hypervisor-directed usage of CPU resources is shown in accordance with an illustrative embodiment. The process shown in FIGS. 10A-10B may be implemented in a computer, such as, for example, computer 101 in FIG. 1 or physical host computer 201 in FIG. 9. For example, the process shown in FIGS. 10A-10B may be implemented by hypervisor-directed CPU utilization code 200 in FIG. 1 or hypervisor 218 in FIG. 9.

The process begins when the physical host computer, using the hypervisor, collects physical CPU usage data from a plurality of guest virtual machines over a defined period of time (step 1002). The physical host computer includes a plurality of physical CPUs, the plurality of guest virtual machines having a plurality of logical CPUs, and the hypervisor that runs the plurality of guest virtual machines. Each one of the plurality of logical CPUs can run on each one of the plurality of physical CPUs. The physical host computer, using the hypervisor, performs an analysis of the physical CPU usage data collected from the plurality of guest virtual machines (step 1004). The physical host computer, using the hypervisor, determines physical CPU usage patterns of the plurality of guest virtual machines over the defined period of time based on the analysis of the physical CPU usage data collected from the plurality of guest virtual machines (step 1006).

The physical host computer, using the hypervisor, predicts future physical CPU usage of each of the plurality of guest virtual machines based on the physical CPU usage patterns of the plurality of guest virtual machines over the defined period of time (step 1008). The physical host computer, using the hypervisor, identifies a subset of the plurality of guest virtual machines that are predicted to consume a decreased percentage of physical CPU runtime than configuration of the subset of the plurality of guest virtual machines of logical CPUs allows based on predicting the future physical CPU usage of each of the plurality of guest virtual machines (step 1010). In addition, the host computer, using the hypervisor, identifies at least one physical CPU of the plurality of physical CPUs that will have additional available processing capacity based on the subset of the plurality of guest virtual machines that are predicted to consume the decreased percentage of physical CPU runtime than the configuration of the subset of the plurality of guest virtual machines of logical CPUs allows (step 1012).

The physical host computer, using the hypervisor, determines a logical to physical CPU relationship mapping between a subset of the plurality of logical CPUs and a subset of the plurality of physical CPUs using a CPU topology of the physical host computer (step 1014). The physical host computer, using the hypervisor, distributes information regarding the additional available processing capacity of the at least one physical CPU to the plurality of guest virtual machines on a per-logical CPU basis based on the logical to physical CPU relationship mapping between the subset of the plurality of logical CPUs and the subset of the plurality of physical CPUs enabling the plurality of guest virtual machines to distribute workload based on predicted processing capacities of corresponding logical CPUs (step 1016). Thereafter, the process terminates.

Thus, illustrative embodiments of the present disclosure provide a computer-implemented method, computer system, and computer program product for hypervisor-directed usage of CPU resources. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for hypervisor-directed usage of central processing unit (CPU) resources, the computer-implemented method comprising:
determining, by a computer, using a hypervisor, a logical to physical CPU relationship mapping between a subset of a plurality of logical CPUs and a subset of a plurality of physical CPUs using a CPU topology of the computer; and
distributing, by the computer, using the hypervisor, information regarding additional available processing capacity of at least one physical CPU to a plurality of guest virtual machines on a per-logical CPU basis based on the logical to physical CPU relationship mapping between the subset of the plurality of logical CPUs and the subset of the plurality of physical CPUs enabling the plurality of guest virtual machines to distribute workload based on predicted processing capacities of corresponding logical CPUs.

2. The computer-implemented method of claim 1, further comprising:
collecting, by the computer, using the hypervisor, physical CPU usage data from the plurality of guest virtual machines over a period of time; and
performing, by the computer, using the hypervisor, an analysis of the physical CPU usage data collected from the plurality of guest virtual machines.

3. The computer-implemented method of claim 2, further comprising:
determining, by the computer, using the hypervisor, physical CPU usage patterns of the plurality of guest virtual machines over the period of time based on the analysis of the physical CPU usage data collected from the plurality of guest virtual machines; and
predicting, by the computer, using the hypervisor, future physical CPU usage of each of the plurality of guest virtual machines based on the physical CPU usage patterns of the plurality of guest virtual machines over the period of time.

4. The computer-implemented method of claim 3, further comprising:
identifying, by the computer, using the hypervisor, the subset of the plurality of guest virtual machines that are predicted to consume a decreased percentage of physical CPU runtime than configuration of the subset of the plurality of guest virtual machines of logical CPUs allows based on the future physical CPU usage of each of the plurality of guest virtual machines.

5. The computer-implemented method of claim 4, further comprising:
identifying, by the computer, using the hypervisor, the at least one physical CPU of the plurality of physical CPUs that will have the additional available processing capacity based on the subset of the plurality of guest virtual machines that are predicted to consume the decreased percentage of physical CPU runtime than the configuration of the subset of the plurality of guest virtual machines of logical CPUs allows.

6. The computer-implemented method of claim 1, wherein the computer includes the plurality of physical CPUs, the plurality of guest virtual machines having the plurality of logical CPUs, and the hypervisor that runs the plurality of guest virtual machines.

7. The computer-implemented method of claim 1, wherein each one of the plurality of logical CPUs can run on each one of the plurality of physical CPUs.

8. A computer system for hypervisor-directed usage of CPU resources, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
determine, using a hypervisor, a logical to physical CPU relationship mapping between a subset of a plurality of logical CPUs and a subset of a plurality of physical CPUs using a CPU topology of the computer system; and
distribute, using the hypervisor, information regarding additional available processing capacity of at least one physical CPU to a plurality of guest virtual machines on a per-logical CPU basis based on the logical to physical CPU relationship mapping between the subset of the plurality of logical CPUs and the subset of the plurality of physical CPUs enabling the plurality of guest virtual machines to distribute workload based on predicted processing capacities of corresponding logical CPUs.

9. The computer system of claim 8, wherein the set of processors further executes the program instructions to:
collect, using the hypervisor, physical CPU usage data from the plurality of guest virtual machines over a period of time; and
perform, using the hypervisor, an analysis of the physical CPU usage data collected from the plurality of guest virtual machines.

10. The computer system of claim 9, wherein the set of processors further executes the program instructions to:
determine, using the hypervisor, physical CPU usage patterns of the plurality of guest virtual machines over the period of time based on the analysis of the physical CPU usage data collected from the plurality of guest virtual machines; and
predict, using the hypervisor, future physical CPU usage of each of the plurality of guest virtual machines based on the physical CPU usage patterns of the plurality of guest virtual machines over the period of time.

11. The computer system of claim 10, wherein the set of processors further executes the program instructions to:
identify, using the hypervisor, the subset of the plurality of guest virtual machines that are predicted to consume a decreased percentage of physical CPU runtime than configuration of the subset of the plurality of guest virtual machines of logical CPUs allows based on the future physical CPU usage of each of the plurality of guest virtual machines.

12. The computer system of claim 11, wherein the set of processors further executes the program instructions to:
identify, using the hypervisor, the at least one physical CPU of the plurality of physical CPUs that will have the additional available processing capacity based on the subset of the plurality of guest virtual machines that are predicted to consume the decreased percentage of physical CPU runtime than the configuration of the subset of the plurality of guest virtual machines of logical CPUs allows.

13. The computer system of claim 8, wherein the computer system includes the plurality of physical CPUs, the plurality of guest virtual machines having the plurality of logical CPUs, and the hypervisor that runs the plurality of guest virtual machines.

14. A computer program product for hypervisor-directed usage of CPU resources, the computer program product comprising a set of computer-readable storage media having program instructions collectively stored therein, the program instructions executable by a computer to cause the computer to:
determine, using a hypervisor, a logical to physical CPU relationship mapping between a subset of a plurality of logical CPUs and a subset of a plurality of physical CPUs using a CPU topology of the computer; and
distribute, using the hypervisor, information regarding additional available processing capacity of at least one physical CPU to a plurality of guest virtual machines on a per-logical CPU basis based on the logical to physical CPU relationship mapping between the subset of the plurality of logical CPUs and the subset of the plurality of physical CPUs enabling the plurality of guest virtual machines to distribute workload based on predicted processing capacities of corresponding logical CPUs.

15. The computer program product of claim 14, wherein the program instructions further cause the computer to:
collect, using the hypervisor, physical CPU usage data from the plurality of guest virtual machines over a period of time; and
perform, using the hypervisor, an analysis of the physical CPU usage data collected from the plurality of guest virtual machines.

16. The computer program product of claim 15, wherein the program instructions further cause the computer to:
determine, using the hypervisor, physical CPU usage patterns of the plurality of guest virtual machines over the period of time based on the analysis of the physical CPU usage data collected from the plurality of guest virtual machines; and
predict, using the hypervisor, future physical CPU usage of each of the plurality of guest virtual machines based on the physical CPU usage patterns of the plurality of guest virtual machines over the period of time.

17. The computer program product of claim 16, wherein the program instructions further cause the computer to:
identify, using the hypervisor, the subset of the plurality of guest virtual machines that are predicted to consume a decreased percentage of physical CPU runtime than configuration of the subset of the plurality of guest virtual machines of logical CPUs allows based on the future physical CPU usage of each of the plurality of guest virtual machines.

18. The computer program product of claim 17, wherein the program instructions further cause the computer to:
identify, using the hypervisor, the at least one physical CPU of the plurality of physical CPUs that will have the additional available processing capacity based on the subset of the plurality of guest virtual machines that are predicted to consume the decreased percentage of physical CPU runtime than the configuration of the subset of the plurality of guest virtual machines of logical CPUs allows.

19. The computer program product of claim 14, wherein the computer includes the plurality of physical CPUs, the plurality of guest virtual machines having the plurality of logical CPUs, and the hypervisor that runs the plurality of guest virtual machines.

20. The computer program product of claim 14, wherein each one of the plurality of logical CPUs can run on each one of the plurality of physical CPUs.
